(19) United States
(12) Patent Application Publication
(10) Pub. No.: US 2016/0073446 A1
(43) Pub. Date: Mar. 10, 2016

(54) APPARATUS AND METHODS FOR PERFORMING DISCONTINUOUS RECEPTION (DRX) AND LONG TIMESCALE DISCONTINUOUS TRANSMISSION (LDTX) IN A WIRELESS COMMUNICATIONS SYSTEM

(71) Applicant: QUALCOMM Incorporated, San Diego, CA (US)

(72) Inventors: Huang Lou, San Diego, CA (US); Rashid Ahmed Akbar Attar, San Diego, CA (US); Jun Hu, San Diego, CA (US)

(21) Appl. No.: 14/664,024

(22) Filed: Mar. 20, 2015

Related U.S. Application Data
(60) Provisional application No. 62/047,193, filed on Sep. 8, 2014.

(51) Int. Cl. H04W 76/04; H04W 52/02

(52) U.S. Cl. CPC H04W 76/048; H04W 52/028

(57) ABSTRACT

Aspects of the present disclosure provide a method of performing discontinuous reception (DRX) and long timescale discontinuous transmission (LDTX) in a wireless communications system. An access terminal (AT) includes a communications interface configured to receive a forward link (FL) transmission from a network, wherein the FL transmission includes a plurality of frames each including at least two half slots. The AT further includes a computer-readable medium with instructions and a processing circuit coupled to the communications interface and the computer-readable medium. The AT is configured to enable a LDTX mode including an LDTX on period and an LDTX off period. In the LDTX off period, the AT autonomously enables a DRX mode in at least a portion of a half slot based on data contained in the half slot.

### CROSS-REFERENCE TO RELATED APPLICATIONS

This application claims priority to and the benefit of provisional patent application No. 62/047,193 filed in the United States Patent and Trademark Office on 8 Sep. 2014, the entire content of which is incorporated herein by reference.

### TECHNICAL FIELD

The technology discussed below relates generally to wireless communications, and more specifically, to methods and devices for facilitating discontinuous reception (DRX) and long timescale discontinuous transmission (LDTX) of access terminals operating in a wireless communications system.

### BACKGROUND

Wireless communication systems are widely deployed to provide various communication services such as telephony, video, data, messaging, broadcasts, and so on. Wireless communications networks, which are usually multiple access networks, support communications for multiple users by sharing the available network resources. Examples of such networks include networks based on the Global System for Mobile Communications (GSM), the Universal Mobile Telecommunications System (UMTS), and Long Term Evolution (LTE), which are defined by the Third Generation Partnership Project (3GPP), as well as CDMA2000 1× and 1×EV-DO, which are defined by the Third Generation Partnership Project 2 (3GPP2), among others.

Wireless communication systems may be accessed by various types of devices adapted to facilitate wireless communications, where multiple devices share the available system resources (e.g., time, frequency, processing power, bandwidth, and power). Examples of such wireless communications systems include code-division multiple access (CDMA) systems, time-division multiple access (TDMA) systems, frequency-division multiple access (FDMA) systems, and orthogonal frequency-division multiple access (OFDMA) systems. Multiple types of devices are adapted to utilize such wireless communications systems. Such devices may be generally referred to as access terminals (ATs). ATs are typically powered by a limited power source (e.g., rechargeable battery). Therefore, reducing the power consumption of an AT can result in lower battery requirements and/or longer operating time between charging.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provide a method of wireless communication operable at an access terminal (AT). The AT receives a forward link (FL) transmission from a network, wherein the FL transmission includes a plurality of frames each including at least two half slots. The AT enables a long timescale discontinuous transmission (LDTX) mode including an LDTX on period and an LDTX off period. In the LDTX off period, the AT autonomously enables a discontinuous reception (DRX) mode in at least a portion of a half slot of the at least two half slots based on data contained in the half slot.

Another aspect of the disclosure provides an access terminal (AT) including a communications interface configured to receive a forward link (FL) transmission from a network, wherein the FL transmission includes a plurality of frames each including at least two half slots. The AT further includes a computer-readable medium including instructions, and a processing circuit coupled to the communications interface and the computer-readable medium. The processing circuit configured by the instructions, includes a discontinuous transmission (DTX) block configured to enable a long timescale discontinuous transmission (LDTX) mode including an LDTX on period and an LDTX off period. The processing circuit configured by the instructions, further includes a discontinuous reception (DRX) block configured to, in the LDTX off period, autonomously enable a DRX mode in at least a portion of a half slot based on data contained in the half slot.

Another aspect of the disclosure provides an access terminal (AT) for wireless communications. The AT includes means for receiving a forward link (FL) transmission from a network, wherein the FL transmission includes a plurality of frames each including at least two half slots. The AT further includes means for enabling a long timescale discontinuous transmission (LDTX) mode including an LDTX on period and an LDTX off period. The AT further includes means for in the LDTX off period, autonomously enabling a discontinuous reception (DRX) mode in at least a portion of a half slot of the at least two half slots based on data contained in the half slot.

Another aspect of the disclosure provides a computer-readable medium including instructions for causing an access terminal (AT) to perform wireless communications. The instructions causes the AT to receive a forward link (FL) transmission from a network, wherein the FL transmission includes a plurality of frames each comprising at least two half slots. The instructions further causes the AT to enable a long timescale discontinuous transmission (LDTX) mode including an LDTX on period and an LDTX off period. The instructions further causes the AT to in the LDTX off period, autonomously enable a DRX mode in at least a portion of a half slot based on data contained in the half slot.

These and other aspects of the disclosure will become more fully understood upon a review of the detailed description, which follows. Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various aspects of the disclosure discussed herein. In similar fashion, while exemplary embodiments may be discussed below as device, system, or method embodiments it should be understood that such exemplary embodiments can be implemented in various devices, systems, and methods.

### DRAWINGS

FIG. 1 is a block diagram illustrating an example of a network environment in which one or more aspects of the present disclosure may find application.

FIG. 2 is a block diagram illustrating an example of a protocol stack architecture which may be implemented by an access terminal according to some aspects of the disclosure.

FIG. 3 is a block diagram illustrating an access terminal configured to autonomously perform a discontinuous reception (DRX) operation in a long timescale discontinuous transmission (LDTX) off period in accordance with some aspects of the disclosure.

FIG. 4 is a diagram illustrating a LDTX transmission including on periods and off periods in accordance with an aspect of the disclosure.

FIG. 5 is a block diagram illustrating an example of a receive (RX) path in accordance with an aspect of the disclosure.

FIG. 6 is a diagram illustrating a DRX operation in an LDTX off period in accordance with an aspect of the disclosure.

FIG. 7 is a diagram illustrating an EV-DO forward link frame structure in accordance with an aspect of the disclosure.

FIG. 8 is a flow chart illustrating a method of autonomously performing DRX in an LDTX off period in accordance with some aspects of the disclosure.

FIG. 9 is a flow chart illustrating a method of autonomously enabling DRX mode in an LDTX off period in accordance with some aspects of the disclosure.

FIG. 10 is a flow chart illustrating another method of autonomously enabling DRX mode in an LDTX off period in accordance with some aspects of the disclosure.

FIG. 11 is a flow chart illustrating a method of controlling an RX path in a DRX off period in accordance with some aspects of the disclosure.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

The various concepts presented throughout this disclosure may be implemented across a broad variety of telecommunication systems, network architectures, and communication standards. Certain aspects of the disclosure are described below for CDMA Evolution-Data Optimized (EV-DO) protocols and systems, and related terminology may be found in much of the following description. However, those of ordinary skill in the art will recognize that one or more aspects of the present disclosure may be employed and included in one or more other wireless communication protocols and systems.

EV-DO is a wireless telecommunications standard used for transmission of broadband data. EV-DO uses code-division multiple access (CDMA), as well as time-division multiplexing (TDM) to improve individual user throughput and overall system throughput. One type of EV-DO is commonly referred to as 1×EV-DO that includes Revision 0, Revision A, and Revision B, each of which provides benefits over previous versions of EV-DO.

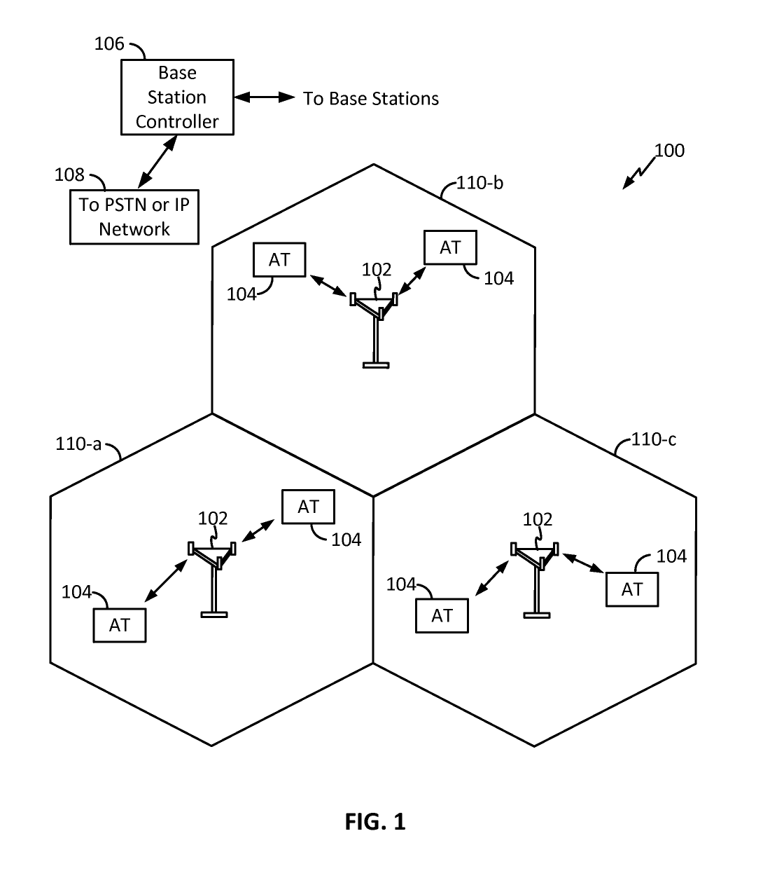

Referring now to FIG. 1, a block diagram is shown illustrating an example of a network environment in which one or more aspects of the present disclosure may find application. The wireless communication system 100 generally includes one or more base stations 102, one or more access terminals (ATs) 104, one or more base station controllers (BSC) 106, and a core network 108 providing access to a public switched telephone network (PSTN) (e.g., via a mobile switching center/visitor location register (MSC/VLR)) and/or to an IP network (e.g., via a packet data switching node (PDSN)). The system 100 may support operation on multiple carriers (waveform signals of different frequencies). Multi-carrier transmitters can transmit modulated signals simultaneously on multiple carriers or frequencies. Each modulated signal may be a CDMA signal, a TDMA signal, an OFDMA signal, a Single Carrier Frequency Division Multiple Access (SC-FDMA) signal, etc. Each modulated signal may be sent on a different carrier and may carry control information (e.g., pilot signals), overhead information, user traffic or data, etc.

The base stations 102 can wirelessly communicate with the access terminals 104 via one or more base station antennas. The base stations 102 may each be implemented generally as a device adapted to facilitate wireless connectivity (for one or more access terminals 104) to the wireless communications system 100. A base station 102 may also be referred to by those skilled in the art as an access point, a base transceiver station (BTS), a radio base station, a radio transceiver, a transceiver function, a basic service set (BSS), an extended service set (ESS), a Node B, an eNB, a femto cell, a pico cell, and/or some other suitable terminology.

The base stations 102 are configured to communicate with the access terminals 104 under the control of the base station controller 106. Each of the base stations 102 can provide communication coverage for a respective geographic area. The coverage area 110 for each base station 102 here is identified as cells 110-a, 110-b, or 110-c. The coverage area 110 for a base station 102 may be divided into sectors (not shown, but making up only a portion of the coverage area). In various examples, the system 100 may include base stations 102 of different types.

One or more access terminals 104 may be dispersed throughout the coverage areas 110. Each access terminal 104 may communicate with one or more base stations 102. An access terminal 104 may generally include one or more devices that communicate with one or more other devices through wireless signals. Such an access terminal (AT) 104 may also be referred to by those skilled in the art as a user equipment (UE), a mobile station (MS), a subscriber station, a mobile unit, a subscriber unit, a wireless unit, a remote unit, a mobile device, a wireless device, a wireless communications device, a remote device, a mobile subscriber station, a mobile terminal, a wireless terminal, a remote terminal, a handset, a terminal, a user agent, a mobile client, a client, or some other suitable terminology. An access terminal 104 may include a mobile terminal and/or an at least substantially fixed terminal Examples of an access terminal 104 include a mobile phone, a pager, a wireless modem, a personal digital assistant, a personal information manager (PIM), a personal media player, a palmtop computer, a laptop computer, a tablet computer, a television, an appliance, an e-reader, a digital video recorder (DVR), a machine-to-machine (M2M) device, meter, entertainment device, toy, automotive/vehicle modules, sensor, sensing device, wearable device, router, smart watch, Internet-of-things device, and/or other communication/computing device which communicates, at least partially, through a wireless or cellular network.

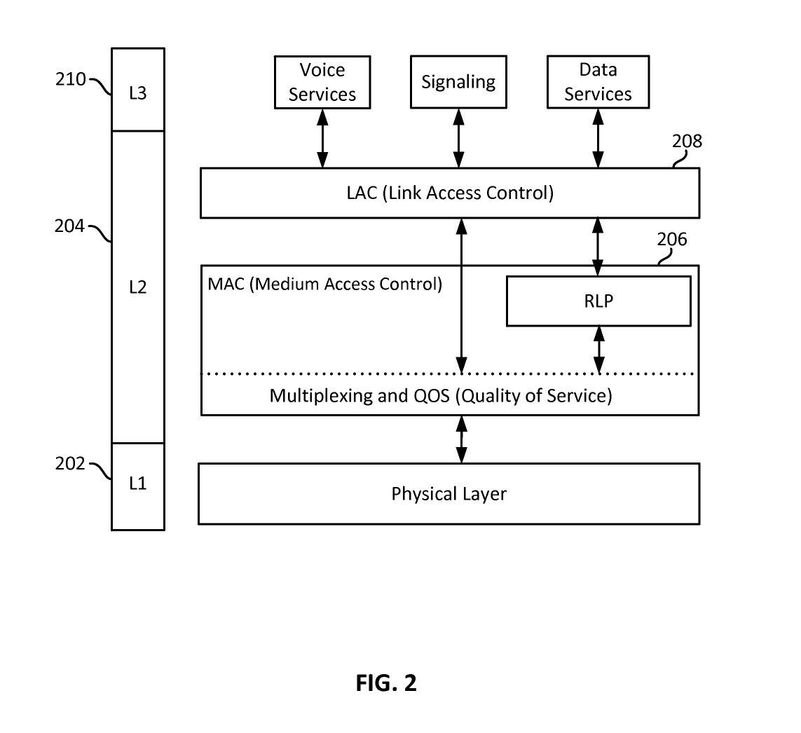

The wireless communications system 100 may employ CDMA data-optimized architecture and/or protocols, such as an EV-DO network. The access terminal 104 may be adapted to employ a protocol stack architecture for communicating data between the access terminal 104 and one or more network nodes (e.g., the base station 102) of the wireless communication system 100. A protocol stack generally includes a conceptual model of the layered architecture for communication protocols in which layers are represented in order of their numeric designation, where transferred data is processed sequentially by each layer, in the order of their representation. Graphically, the “stack” is typically shown vertically, with the layer having the lowest numeric designation at the base. FIG. 2 is a block diagram illustrating an example of a protocol stack architecture which may be implemented by an access terminal 104.

Referring to FIGS. 1 and 2, the protocol stack architecture for the access terminal 104 is shown to generally include three layers: layer 1 (L1), layer 2 (L2), and layer 3 (L3). Layer 1 202 is the lowest layer and implements various physical layer signal processing functions. Layer 1 202 is also referred to herein as the physical layer. This physical layer 202 provides for the transmission and reception of radio signals between the access terminal 104 and a base station 102.

The data link layer, called layer 2 (or “the L2 layer”) 204 is above the physical layer 202 and is responsible for delivery of signaling messages generated by L3. The L2 layer 204 makes use of the services provided by the physical layer 202. The L2 layer 204 may include two sublayers: the Medium Access Control (MAC) sublayer 206, and the Link Access Control (LAC) sublayer 208.

The MAC sublayer 206 is the lower sublayer of the L2 layer 204. The MAC sublayer 206 implements the medium access protocol and is responsible for transport of higher layers' protocol data units using the services provided by the physical layer 202. The MAC sublayer 206 may manage the access of data from the higher layers to the shared air interface.

The LAC sublayer 208 is the upper sublayer of the L2 layer 204. The LAC sublayer 208 implements a data link protocol that provides for the correct transport and delivery of signaling messages generated at the layer 3. The LAC sublayer makes use of the services provided by the lower layers (e.g., layer 1 and the MAC sublayer).

Layer 3 210, which may also be referred to as the upper layer or the L3 layer, originates and terminates signaling messages according to the semantics and timing of the communication protocol between a base station 102 and the access terminal 104. The L3 layer 210 makes use of the services provided by the L2 layer. Information (both data and voice) message are also passed through the L3 layer 210.

In the CDMA2000 standards, each EV-DO frame is divided into 16 slots (time slots). Each slot is a time period in which an AT may transmit and/or receive signals to/from a base station. In a discontinuous transmission (DTX) mode, an AT may stop transmitting signals during DTX off periods. During the DTX off periods, the AT may power down at least some of its TX circuitry. In a discontinuous reception (DRX) mode, an AT may stop receiving signals during DRX off periods. During the DRX off periods, an AT may power down at least some of its RX circuitry. In some aspects of the disclosure, an AT can employ short timescale DTX (SDTX) and long timescale DTX (LDTX) in a reverse link (RL) transmission. The two DTX modes are independent, and the AT may employ different factors to determine whether or not to enable each DTX mode. DTX allows the AT to shut down its transmitter chain and power amplifier for a significant amount of time if there is no FL/RL traffic. The AT may make the decision to perform SDTX and/or LDTX based on FL/RL traffic, handoff, RL loading, DRC Length, etc. In one example, the AT may receive instructions from the network to enable DTX and/or DRX.

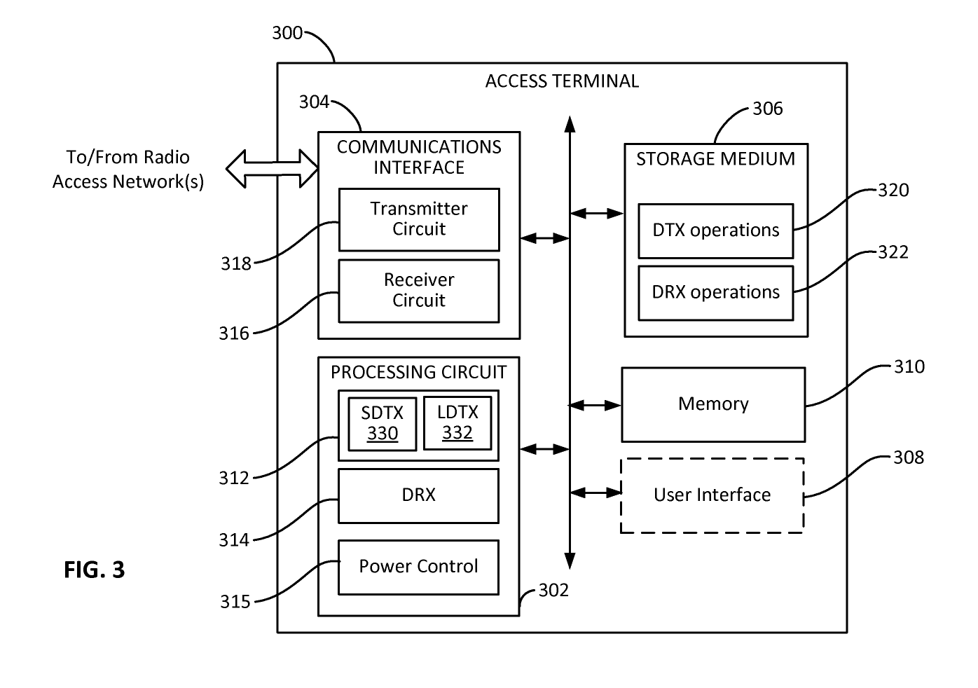

FIG. 3 is a block diagram illustrating an access terminal (AT) 300 operable to perform a DRX operation in an LDTX off period in accordance with some aspects of the present disclosure. The AT 300 includes a processing circuit 302 coupled to or placed in electrical communication with a communications interface 304, a storage medium 306, and a memory 310. Depending upon the nature of the apparatus, a user interface 308 (e.g., keypad, display, speaker, microphone, joystick, touchscreen, touchpad, gesture sensors, motion sensors) may also be provided. The processing circuit 302 may utilize the memory 310 for storing information useful for the processing of information while execution software. The various components and blocks of the AT 300 may be implemented in software, firmware, hardware, or a combination thereof.

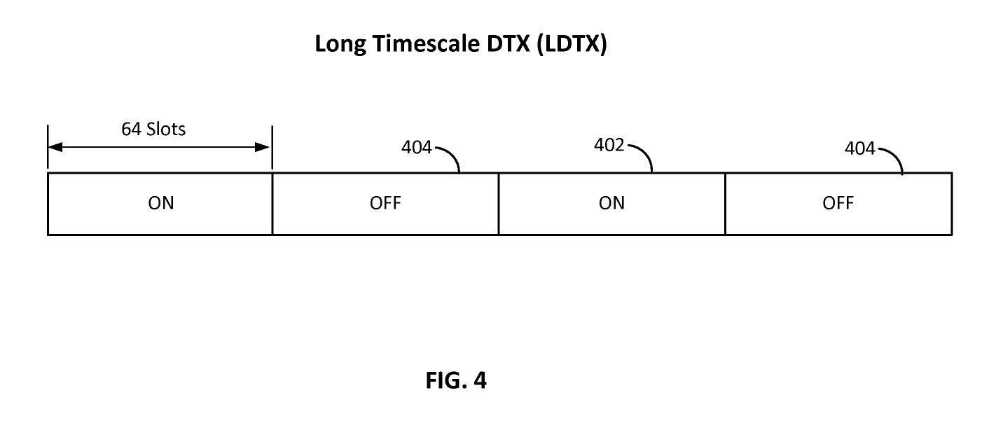

The processing circuit 302 is arranged to obtain, process, receive and/or send data, control data access and storage, issue commands, and control other desired operations. The processing circuit 302 may include circuitry, blocks, and components configurable to implement and execute desired programming and instructions provided by appropriate media (e.g., a computer-readable storage medium 306 or an external storage), and/or circuitry adapted to perform one or more functions described in FIGS. 4-11. For example, the processing circuit 302 may be implemented as one or more processors, one or more controllers, and/or other structure configured to execute executable programming Examples of the processing circuit 302 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described in reference to FIGS. 4-11. A general purpose processor may include a microprocessor, as well as any conventional processor, controller, microcontroller, or state machine. The processing circuit 302 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 302 are for illustration and other suitable configurations within the scope of the present disclosure are also contemplated.

The processing circuit 302 is adapted for processing, including the execution of programming, which may be stored on the storage medium 306. As used herein, the term “programming” shall be construed broadly to include without limitation instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

In some aspects of the disclosure, the processing circuit 302 may include a DTX block 312 configured to utilize the communication interface 304 to perform discontinuous transmission (DTX) operations in a DTX mode. Using DTX allows the AT 300 to power down at least some of its transmission (TX) circuitry during the TX off periods (i.e., no transmission). The DTX block 312 includes an SDTX block 330 and an LDTX block 332. The SDTX block 330 may be utilized to perform SDTX operations, and the LDTX block 332 may be utilized to perform LDTX operations. The processing circuit 302 may further include a discontinuous reception (DRX) block 314 configured to utilize the communication interface 304 to perform DRX operations in a DRX mode. Using DRX allows the AT to reduce power consumption by powering down at least some of its reception (RX) circuitry during the RX off periods (i.e., no reception). The processing circuit 302 may further include a power control block 315 configured to enable and/or disable various components of the access terminal 300. For example, when a component is enabled, power may be supplied to the component. When a component is disabled, the component may be powered off or put in a sleep mode consuming less power.

The communications interface 304 is configured to facilitate wireless communications of the AT 300. For example, the communications interface 304 may include circuitry and/or programming adapted to facilitate the communication of information bi-directionally and/or simultaneously with respect to one or more wireless network devices (e.g., base stations or access terminals). In one example, the communications interface 304 may support EV-DO communications. The communications interface 304 may be coupled to one or more antennas (not shown), and includes wireless transceiver circuitry, including at least one receiver circuit 316 (e.g., one or more receiver chains) and/or at least one transmitter circuit 318 (e.g., one or more transmitter chains). The communications interface 304 may further include other commonly known components or circuitry, for example, phase-locked loop (PLL) circuitry, analog-to-digital converters (ADC), and other generally known components including various filters, converters, mixers, amplifiers, signal processors, etc. During DRX and/or DTX operations, one or more of the components of the communications interface 304 may be disabled (i.e., powered off or put in low-power mode).

The storage medium 306 may represent one or more processor-readable or computer-readable devices or medium for storing programming, such as processor executable code or instructions (e.g., software, firmware), electronic data, databases, or other digital information. The storage medium 306 may also be used for storing data that is manipulated by the processing circuit 302 when executing programming. The storage medium 306 may be any available media that can be accessed by a general purpose or special purpose processor, including portable or fixed storage devices, optical storage devices, and various other mediums capable of storing, containing and/or carrying programming By way of example and not limitation, the storage medium 506 may include a processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive, solid state drive), random access memory (RAM), read only memory (ROM), programmable ROM (PROM), erasable PROM (EPROM), electrically erasable PROM (EEPROM), a register, a removable disk, and/or other non-transitory media for storing programming and software, as well as any combination thereof.

The storage medium 306 may be coupled to the processing circuit 302 such that the processing circuit 302 can read information from, and write information to, the storage medium 306. That is, the storage medium 306 can be coupled directly or indirectly to the processing circuit 302 so that the storage medium 306 is at least accessible by the processing circuit 302, including examples where the storage medium 306 is integral to the processing circuit 302 and/or examples where the storage medium 306 is separate from the processing circuit 302 (e.g., resident in the access terminal 300, external to the access terminal 300, distributed across multiple entities).

Programming or software stored at the storage medium 306, when executed by the processing circuit 302, configure various components or blocks of the access terminal 300 to perform one or more of the functions, steps and/or processes described in FIGS. 4-11. In one aspect of the disclosure, the storage medium 306 may include software (e.g. DTX operations 320 and DRX operations 322) that when executed by the processing circuit 302, configure the various components and blocks of the apparatus 300 (e.g., the DTX block 312, DRX block 314, power control block 315, and communications interface 304) to perform the DTX and/or DRX operations described in FIGS. 4-10.

Thus, according to one or more aspects of the present disclosure, the processing circuit 302 is adapted or configured to perform (in conjunction with the storage medium 306) any or all of the processes, functions, steps, and/or routines for any or all of the access terminals described in FIGS. 1 and/or 3. As used herein, the term “adapted” in relation to the processing circuit 302 may refer to the processing circuit 302 being one or more of configured, employed, implemented, operable, and/or programmed (in conjunction with the storage medium 306) to perform a particular process, function, step, and/or routine according to various features described in reference to FIGS. 4-11.

In one aspect of the disclosure, the AT 300 (e.g., the DTX block 312 configured by the DTX operations software 320) can perform SDTX operations and/or LDTX operations in the reverse link. The two DTX modes are independent, and the AT 300 may employ different factors for determining whether or not to enable each DTX mode. In one example, when SDTX mode is enabled, the AT may enable transmission (SDTX on period) for 2 slots and disable transmission (SDTX off period) for 2 slots. To enable the SDTX mode, the AT 300 may consider various factors that are monitored by the communications interface 304. When the AT 300 determines that some or all of the factors are present, the AT 300 may enable the SDTX mode, independent of whether the LDTX mode is enabled or not. To determine whether or not to enable LDTX mode, the AT 300 may consider various factors that are monitored by the communications interface 304. When the AT 300 determines that some or all of the factors are present, the AT 300 may enable the LDTX mode, independent of whether the SDTX mode is enabled or not. DTX allows the AT 300 to shutdown it transmitter chain and power amplifier for a significant amount of time if there is no FL/RL traffic. The AT 300 may make the decision to perform SDTX and/or LDTX based on FL/RL traffic, handoff, RL loading, DRC Length, etc.

When the LDTX mode is enabled, communication between the AT 300 and one or more network entities (e.g., a base station) can be carried out as shown in the example depicted in FIG. 4. As illustrated, the AT 300 may employ a periodic on and off pattern. In one example, the duration of the LDTX on period 402 may correspond to the length of the data source control (DSC) field of the reverse link (RL). The DSC length refers to the number of slots the DSC channel is transmitted for in a certain network. In one example, the DSC length can be 64 slots in duration, and the LDTX on period 402 and LDTX off period 404 may be of equal duration. In this example, therefore, the AT 300 operating with the LDTX mode enabled may power on the transmitter circuit 318 for 64 slots in the LDTX on period, and power off the transmitter circuit 318 for 64 slots in the LDTX off period. In other aspects of the disclosure, other variations are also possible including variations in the durations of LDTX on and off periods. In one example, when LDTX mode is enabled, the AT may enable transmission (LDTX on period) for certain number of slots and disable transmission (LDTX off period) for certain number of slots. In general, when LDTX is enabled, during the LDTX off period (e.g., off period 404), the AT is not served (i.e. no FL traffic) by the network (e.g., base station) but may keep all or some circuitry of its RX path turned on, which can undesirably consume significant amount of power unnecessarily.

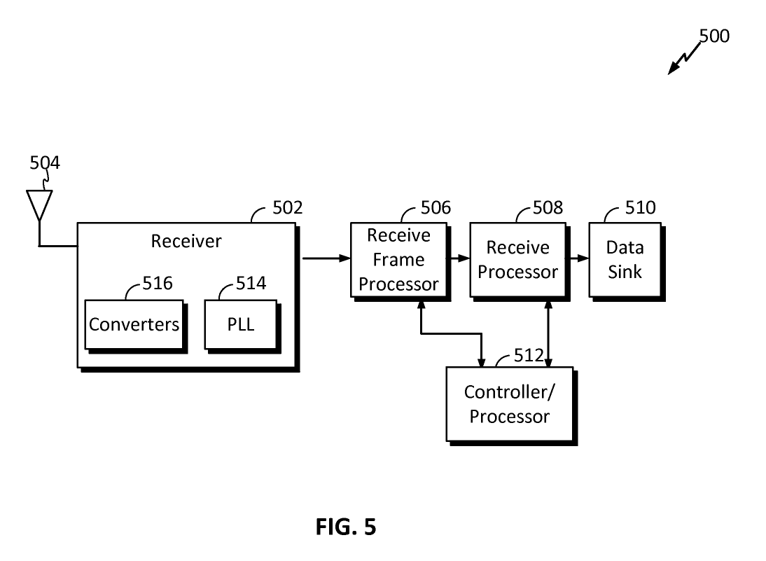

FIG. 5 is a block diagram illustrating an example of an RX path 500 in accordance with an aspect of the disclosure. The RX path 500 may be included in the receiver circuit 316 of the apparatus 300. The RX path 500 may include other generally known components not shown in the figure. In the RX path 500, a receiver 502 receives a transmission through an antenna 504 and processes the transmission to recover the information modulated onto the carrier (e.g., a CDMA2000 carrier). The information recovered by the receiver 502 is provided to a receive frame processor 506, which parses each frame, and provides information (e.g., data, control, and reference signals) from the frames to a receive processor 508. The receive processor 508 descrambles and despreads the symbols based on the modulation scheme of the transmission. The data carried by the successfully decoded frames may then be provided to a data sink 510, which may represent applications running in an apparatus 300. Control signals carried by successfully decoded frames may be provided to a controller/processor 512. When frames are unsuccessfully decoded by the receive processor 508, the controller/processor 512 may also use an acknowledgement (ACK) and/or negative acknowledgement (NACK) protocol to support retransmission requests for those frames. The controller/processor 512 may be the processor circuit 302 of FIG. 3. The receiver 502 may include various components such as amplifiers, mixers, phase-locked loop (PLL) circuitry 514, and converters 516 (e.g., analog-to-digital converter). In various aspects of the disclosure, the components of the RX path 500 may be powered off or disabled individually when it is not being utilized (e.g., in DRX off periods). When any of the components of the RX path 500 is powered off or disabled, it may be completely powered off or in a reduced power consumption state (e.g., sleep mode).

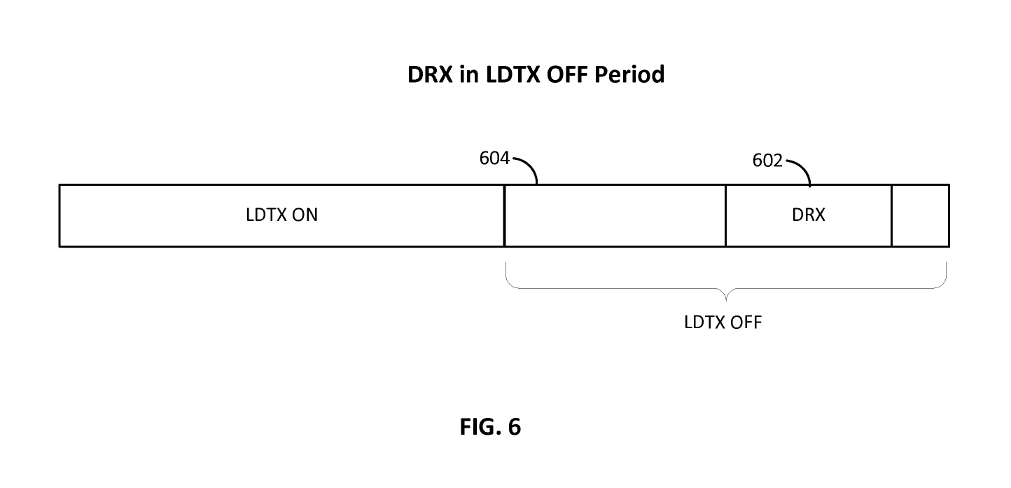

In some aspects of the disclosure, referring to FIG. 6, a DRX mode 602 may be enabled in an LDTX off period 604 such that the AT can power down at least some parts or components of its RX path in the LDTX off period. In some aspects of the disclosure, the AT can enable or disable DRX mode in an LDTX off period in different scenarios for different forward link (FL) EV-DO half slots. In one aspect of the disclosure, the DRX mode may be enabled for certain half slots and disabled in other half slots based on the information transmitted in the corresponding half slots.

In one aspect of the disclosure, if an AT expects or anticipates potential control channel data in the upcoming FL transmission or half slot, the AT may not enable DRX in the LDTX off period. In another aspect of the disclosure, if the AT expects or anticipates the data rate control lock (DRC Lock) data in the upcoming FL transmission or half slot, the AT may keep the RX path powered on (i.e., disable DRX) for at least the pilot and MAC segments of a half slot while powering off the RX path for all the data segments of the same half slot.

The AT expects or anticipates the upcoming FL transmission or half slot carrying certain data (e.g., control channel or DRC Lock data) when the AT has knowledge of a scheduled transmission of such data, or there is a sufficiently high probability of such transmission. Because the AT is synchronized in timing with the network, it can anticipate or expect when the control channel data and/or DRC Lock data will be transmitted by the network. For example, the AT is aware that a synchronous control channel may be transmitted once every 256 slots, and a DRC Lock may be transmitted in one out of every 4 slots. The DRC Lock, which is carried in the MAC channel, indicates to the AT whether or not the data rate control (DRC) information sent by the AT was correctly decoded by the network. For the other FL half slots, the AT may power off (i.e., disable DRX) one or more components of the RX path. Throughout this specification, powering off an RX path may include powering off all or only some components of the RX path and related circuitry such as the PLL and/or analog-to-digital converter. An RX path (e.g., RX path 500) may include various amplifiers, mixer, filters, converters, signal processors, level shifters, transceivers, and other known circuitry for receiving and processing radio frequency signals.

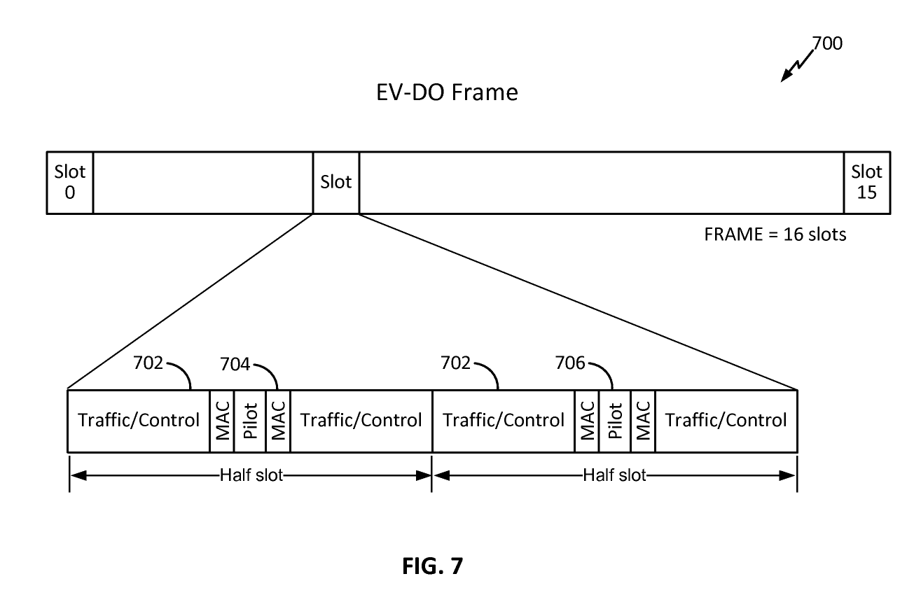

FIG. 7 is a diagram illustrating an EV-DO FL frame 700 according to one aspect of the present disclosure. The AT 300 may be configured to receive and process the EV-DO frame 700 in accordance with the processes described in relation to FIGS. 4-11. In EV-DO, one physical channel includes time-multiplexed pilot, MAC, traffic, and control channels. For example, an EV-DO frame 700 has 16 slots, and each slot has a duration of 1.667 milliseconds (ms). Some slots are used to broadcast the control channel to all ATs, and some slots are used to address the ATs individually. Each half slot includes two control/traffic segments 702 for the control and traffic channels, two MAC segments 704 for the MAC channel, and a pilot segment 706 for the pilot channel. The control/traffic segments 702 may be used to send control data (e.g., signaling and overhead information) and user traffic or data to the ATs. Scheduled burst of timing and control information for all ATs may be sent twice in every slot in the MAC segments 704 and pilot segments 706. MAC (Media Access Control) information may be sent in the MAC segments 704. For example, the MAC channel carries control information including the Reverse Power Control (RPC), the Data Rate Control (DRC) Lock, and the reverse activity (RA) channels. A burst of a pilot signal is sent in the pilot segments 706 to facilitate cell acquisition by the ATs. The ATs use the pilot burst to decide which sector sends them the next forward link packet.

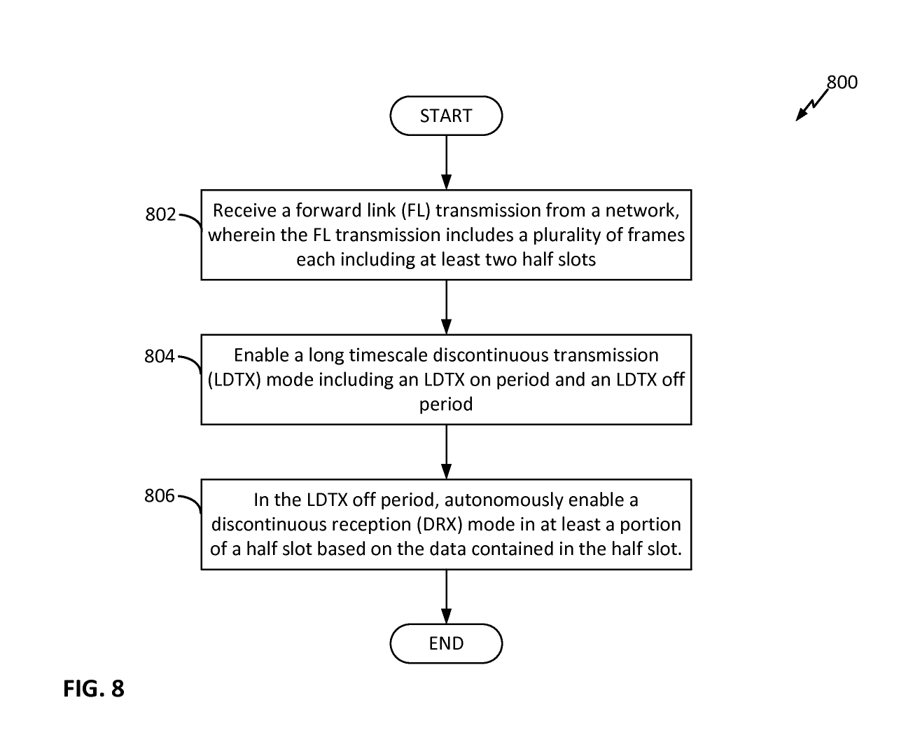

FIG. 8 is a flow chart illustrating a method 800 of autonomously performing DRX in an LDTX off period in accordance with some aspects of the disclosure. The LDTX off period may be the LDTX off period 604 of FIG. 6. During the LDTX off period, the AT 300 does not transmit signals to the network and may power off its transmitter circuit 318 and/or other TX circuitry to reduce power consumption. The method 800 may be performed by any of the ATs illustrated in FIGS. 1 and/or 3. When the AT autonomously performs DRX operations, the AT does not coordinate with the network (e.g., base station) regarding when DRX can be enabled or disabled. The network may not even be aware that DRX is enabled at the AT. Therefore, the network may continue to transmit even when the AT is in a DRX off period. The AT may strategically set the timing of the DRX off periods to avoid or reduce any impact due to DRX operations.

At block 802, the AT may utilize the communications interface 304 (e.g., a receiver circuit 316) to receive a forward link (FL) transmission from a network (e.g., a base station 102), wherein the FL transmission includes a plurality of frames each including at least two half slots. For example, the frames may be EV-DO frames similar to the one shown in FIG. 7. At block 804, the AT may utilize the DTX block 312 to enable a LDTX mode including an LDTX on period and an LDTX off period. At block 806, in the LDTX off period, the AT may utilize the DRX block 314 to autonomously enable a DRX mode in at least a portion of a half slot based on the data contained in the half slot. For example, referring the FIG. 7, the data may be the traffic/control data of the traffic/control segment 702, MAC data of the MAC segment 704, and pilot data of the pilot segment 706.

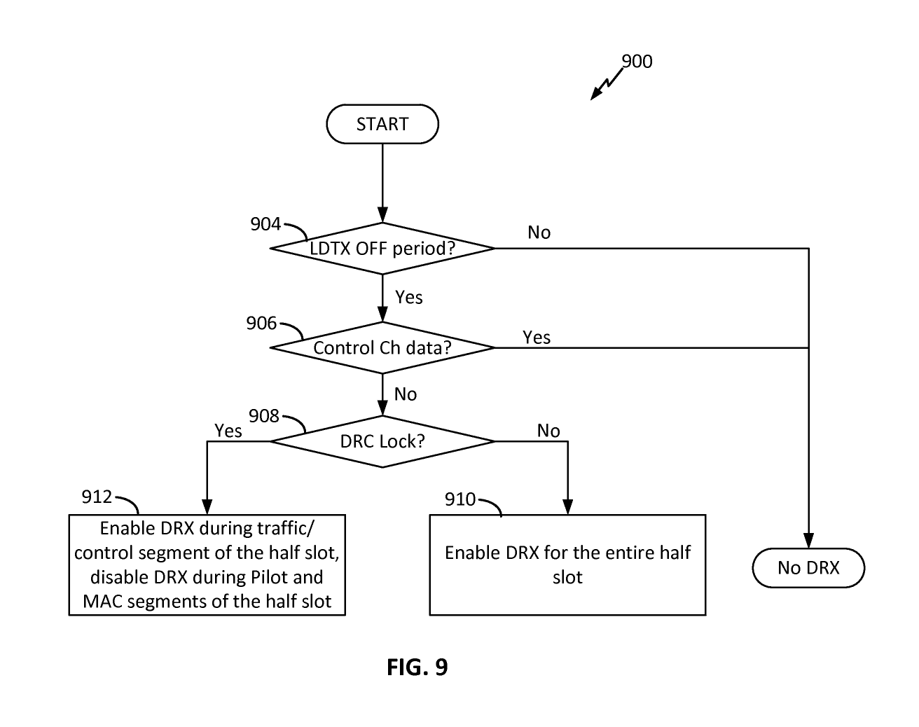

FIG. 9 is a flow chart illustrating a method 900 of autonomously enabling DRX mode in an LDTX off period in accordance with some aspects of the disclosure. The method 900 may be performed by any of the ATs illustrated in FIGS. 1 and/or 3. In one example, the method 900 may be performed by an AT in block 806 of FIG. 8. At decision block 904, if the AT determines that an LDTX off period is ongoing, the method 900 proceeds to decision block 906; otherwise, the AT does not autonomously enable DRX (forgo DRX). At decision block 906, if the AT expects control channel data packets in an upcoming half slot, the AT does not autonomously enable DRX for this half slot; otherwise, the method proceeds to decision block 908. For example, the control channel data packets may be the data transmitted in the traffic/control segment 702 of the half slot.

At decision block 908, if the AT 300 does not expect DRC Lock data in an upcoming half slot, the method proceeds to block 910; otherwise, the method proceeds to block 912. In one example, the AT may utilize the DRX block 314 (see FIG. 3) when the DRX software 322 is executed by the processing circuit 302, to disable or enable DRX in a half slot in an LDTX off period as described in reference to FIG. 9. At block 910, the AT may enable the DRX mode for the entire half slot. That is, the AT may power down one or more components of its RX path including the PLL and/or ADC circuitry for the entire half slot. At block 912, the AT may enable the DRX mode during the traffic/control segments of the half slot (e.g., segments 702 of FIG. 7), but not in the pilot segment 706 and MAC segment 704. In one example, DRC Lock may be transmitted in 16 FL slots in one LDTX off period, and DRX may be enabled for 48 half slots.

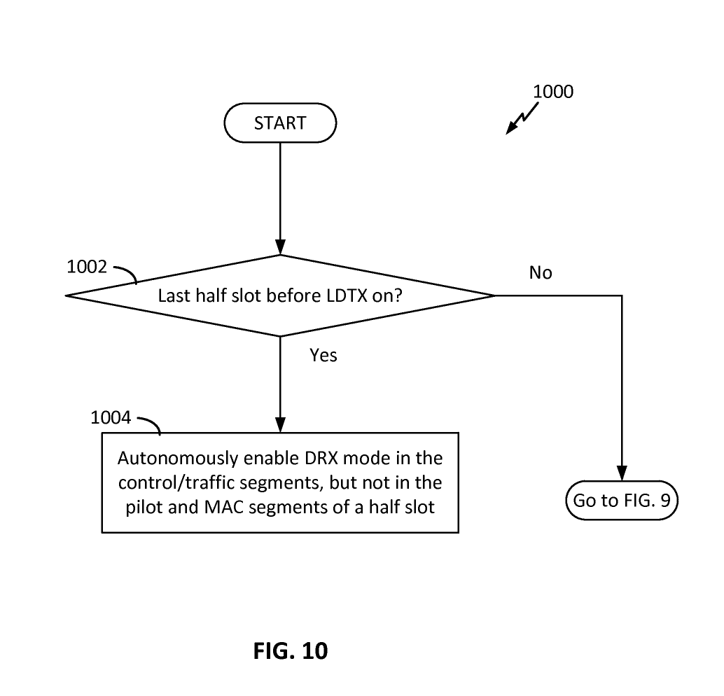

FIG. 10 is a flow chart illustrating a method 1000 of autonomously enabling DRX mode in an LDTX off period in accordance with some aspects of the disclosure. The method 1000 may be performed by any of the ATs illustrated in FIGS. 1 and/or 3. In one example, the method 1000 may be performed by an AT in block 806 of FIG. 8. At decision block 1002, if it is determined that a half slot is the last FL half slot immediately before an LDTX on period (e.g., period 402 of FIG. 4), the AT may autonomously enable the DRX mode in the control/traffic segments, but not in the pilot and MAC segments of this half slot, in block 1004. Therefore, the AT can have sufficient time to warm up and/or initiate certain circuitry (e.g., LDTX block 332 and communications interface 304) to support the LDTX on period.

At decision block 1002, if it is determined that a half slot is not the last FL half slot immediately before an LDTX on period, the AT may perform the method 900 of FIG. 9 to autonomously enable DRX mode in certain conditions as described above in reference to FIG. 9. By utilizing the above described techniques to enable/disable DRX mode in an LDTX off period, the AT may reduce its power consumption, thus reducing battery requirements and/or providing longer operating time between charging.

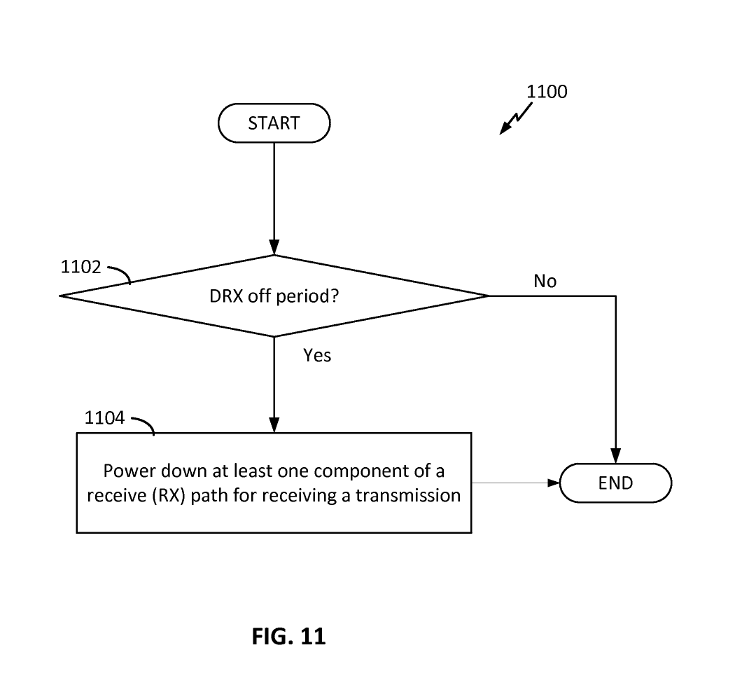

FIG. 11 is a flow chart illustrating a method 1100 of powering down an RX path in a DRX off period in accordance with some aspects of the disclosure. The method 1100 may be performed by any of the ATs illustrated in FIGS. 1 and/or 3. In one example, the method 1100 may be performed by an AT in block 806 of FIG. 8. At decision block 1102, if the AT is in a DRX off period, the AT may utilize a power control block 315 to power off, disable, or reduce power consumption of at least one component of an RX path for receiving a transmission. In one example, the RX path may be the RX path 500 that may be a part of the communications interface 304 (e.g., receiver circuit 316).

While the above discussed aspects, arrangements, and embodiments are discussed with specific details and particularity, one or more of the components, steps, features and/or functions illustrated in FIGS. 1-11 may be rearranged and/or combined into a single component, step, feature or function or embodied in several components, steps, or functions. Additional elements, components, steps, and/or functions may also be added or not utilized without departing from the present disclosure. The apparatus, devices and/or components illustrated in FIGS. 1 and/or 3 may be configured to perform or employ one or more of the methods, features, parameters, and/or steps described in FIGS. 4-11. The novel algorithms described herein may also be efficiently implemented in software, firmware, and/or embedded in hardware.

While features of the present disclosure may have been discussed relative to certain embodiments and figures, all embodiments of the present disclosure can include one or more of the advantageous features discussed herein. In other words, while one or more embodiments may have been discussed as having certain advantageous features, one or more of such features may also be used in accordance with any of the various embodiments discussed herein. In similar fashion, while exemplary embodiments may have been discussed herein as device, system, or method embodiments, it should be understood that such exemplary embodiments can be implemented in various devices, systems, and methods.

Also, it is noted that at least some implementations have been described as a process or method that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process or method is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a processor-readable storage medium (e.g., a non-transitory computer-readable medium), and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

What is claimed is:

1. A method of wireless communication operable at an access terminal (AT), comprising:
receiving a forward link (FL) transmission from a network, wherein the FL transmission comprises a plurality of frames each comprising at least two half slots;
enabling a long timescale discontinuous transmission (LDTX) mode comprising an LDTX on period and an LDTX off period; and
in the LDTX off period, autonomously enabling a discontinuous reception (DRX) mode in at least a portion of a half slot of the at least two half slots based on data contained in the half slot.

2. The method of claim 1, wherein the autonomously enabling the DRX mode comprises:
enabling the DRX mode at least in a traffic segment of the half slot without coordinating with the network in connection with no user traffic being expected, by the AT, in the half slot.

3. The method of claim 1, wherein the autonomously enabling the DRX mode comprises:
enabling the DRX mode at least in a control segment of the half slot without coordinating with the network in connection with no control channel data being expected, by the AT, in the half slot.

4. The method of claim 1, wherein the autonomously enabling the DRX mode comprises:
forgoing enabling the DRX mode in the half slot in connection with control channel data being expected, by the AT, in the half slot.

5. The method of claim 1, wherein the autonomously enabling the DRX mode comprises:
enabling the DRX mode for the entire half slot in connection with no DRC Lock data being expected, by the AT, in the half slot.

6. The method of claim 1, wherein the autonomously enabling the DRX mode comprises:
enabling the DRX mode in the half slot except during pilot and MAC segments of the half slot in connection with DRC Lock data being expected, by the AT, in the half slot.

7. The method of claim 1, wherein the autonomously enabling the DRX mode comprises:
enabling the DRX mode in the half slot except during pilot and MAC segments of the half slot in connection with the half slot being a last half slot before the LDTX on period.

8. The method of claim 1, wherein the autonomously enabling the DRX mode comprises:
powering off at least one component of a receive (RX) path for receiving the FL transmission.

9. An access terminal (AT) comprising:
a communications interface configured to receive a forward link (FL) transmission from a network, wherein the FL transmission comprises a plurality of frames each comprising at least two half slots;
a computer-readable medium comprising instructions; and
a processing circuit coupled to the communications interface and the computer-readable medium,
wherein the processing circuit configured by the instructions, comprises:
a discontinuous transmission (DTX) block configured to enable a long timescale discontinuous transmission (LDTX) mode comprising an LDTX on period and an LDTX off period; and
a discontinuous reception (DRX) block configured to, in the LDTX off period, autonomously enable a DRX mode in at least a portion of a half slot based on data contained in the half slot.

10. The access terminal of claim 9, wherein for autonomously enabling the DRX mode, the DRX block is further configured to:
enable the DRX mode at least in a traffic segment of the half slot without coordinating with the network in connection with no user traffic being expected, by the AT, in the half slot.

11. The access terminal of claim 9, wherein for autonomously enabling the DRX mode, the DRX block is further configured to:
enable the DRX mode at least in a control segment of the half slot without coordinating with the network in connection with no control channel data being expected, by the AT, in the half slot.

12. The access terminal of claim 9, wherein for autonomously enabling the DRX mode, the DRX block is further configured to:
forgo enabling the DRX mode in the half slot in connection with control channel data being expected, by the AT, in the half slot.

13. The access terminal of claim 9, wherein for autonomously enabling the DRX mode, the DRX block is further configured to:
enable the DRX mode for the entire half slot in connection with no DRC Lock data being expected, by the AT, in the half slot.

14. The access terminal of claim 9, wherein for autonomously enabling the DRX mode, the DRX block is further configured to:
enable the DRX mode in the half slot except during pilot and MAC segments of the half slot in connection with DRC Lock data being expected, by the AT, in the half slot.

15. The access terminal of claim 9, wherein for autonomously enabling the DRX mode, the DRX block is further configured to:
enable the DRX mode in the half slot except during pilot and MAC segments of the half slot in connection with the half slot being a last half slot before the LDTX on period.

16. The access terminal of claim 9, wherein for autonomously enabling the DRX mode, the DRX block is further configured to:
power off at least one component of a receive (RX) path for receiving the FL transmission.

17. An access terminal (AT) comprising:
means for receiving a forward link (FL) transmission from a network, wherein the FL transmission comprises a plurality of frames each comprising at least two half slots;
means for enabling a long timescale discontinuous transmission (LDTX) mode comprising an LDTX on period and an LDTX off period; and
means for in the LDTX off period, autonomously enabling a discontinuous reception (DRX) mode in at least a portion of a half slot of the at least two half slots based on data contained in the half slot.

18. The access terminal of claim 17, wherein the means for autonomously enabling the DRX mode is configured to:
enable the DRX mode at least in a traffic segment of the half slot without coordinating with the network in connection with no user traffic being expected, by the AT, in the half slot.

19. The access terminal of claim 17, wherein the means for autonomously enabling the DRX mode is configured to:
enable the DRX mode at least in a control segment of the half slot without coordinating with the network in connection with no control channel data being expected, by the AT, in the half slot.

20. The access terminal of claim 17, wherein the means for autonomously enabling the DRX mode is configured to:
forgo enabling the DRX mode in the half slot in connection with control channel data being expected, by the AT, in the half slot.

21. The access terminal of claim 17, wherein the means for autonomously enabling the DRX mode is configured to:
enable the DRX mode for the entire half slot in connection with no DRC Lock data being expected, by the AT, in the half slot.

22. The access terminal of claim 17, wherein the means for autonomously enabling the DRX mode is configured to:
enable the DRX mode in the half slot except during pilot and MAC segments of the half slot in connection with DRC Lock data being expected, by the AT, in the half slot.

23. The access terminal of claim 17, wherein the means for autonomously enabling the DRX mode is configured to:
enable the DRX mode in the half slot except during pilot and MAC segments of the half slot in connection with the half slot being a last half slot before the LDTX on period.

24. The access terminal of claim 17, wherein the means for autonomously enabling the DRX mode is configured to:
power off at least one component of a receive (RX) path for receiving the FL transmission.

25. A computer-readable medium comprising instructions for causing an access terminal (AT) to:
receive a forward link (FL) transmission from a network, wherein the FL transmission comprises a plurality of frames each comprising at least two half slots;
enable a long timescale discontinuous transmission (LDTX) mode comprising an LDTX on period and an LDTX off period; and
in the LDTX off period, autonomously enable a DRX mode in at least a portion of a half slot based on data contained in the half slot.

26. The computer-readable medium of claim 25, wherein for autonomously enabling the DRX mode, the instructions further cause the AT to:
enable the DRX mode at least in a traffic segment of the half slot without coordinating with the network in connection with no user traffic being expected, by the AT, in the half slot.

27. The access terminal of claim 25, wherein for autonomously enabling the DRX mode, the instructions further cause the AT to:
enable the DRX mode at least in a control segment of the half slot without coordinating with the network in connection with no control channel data being expected, by the AT, in the half slot.

28. The access terminal of claim 25, wherein for autonomously enabling the DRX mode, the instructions further cause the AT to:
enable the DRX mode for the entire half slot in connection with no DRC Lock data being expected, by the AT, in the half slot.

29. The access terminal of claim 25, wherein for autonomously enabling the DRX mode, the instructions further cause the AT to:
enable the DRX mode in the half slot except during pilot and MAC segments of the half slot in connection with DRC Lock data being expected, by the AT, in the half slot.

30. The access terminal of claim 25, wherein for autonomously enabling the DRX mode, the instructions further cause the AT to:
if the half slot is a last half slot before the LDTX on period, enable the DRX mode in the half slot except during pilot and MAC segments of the half slot in connection with the half slot being a last half slot before the LDTX on period.
